(19) United States
(12) Patent Application Publication
(10) Pub. No.: US 2025/0245714 A1
(43) Pub. Date: Jul. 31, 2025

(54) SYSTEMS AND METHODS FOR IDENTIFICATION OF AMBIGUOUS QUERIES BASED ON PRODUCT TYPE SPECIFICITY

(71) Applicant: Walmart Apollo, LLC, Bentonville, AR (US)

(72) Inventors: Mossaab Bagdouri, Sunnyvale, CA (US); Krishna Sravanthi Rajanala Sai, Dublin, CA (US); Ciya Liao, Fremont, CA (US)

(73) Assignee: Walmart Apollo, LLC, Bentonville, AR (US)

(21) Appl. No.: 19/042,654

(22) Filed: Jan. 31, 2025

Related U.S. Application Data
(60) Provisional application No. 63/627,394, filed on Jan. 31, 2024.

(51) Int. Cl. G06Q 30/0601; G06Q 30/0202

(52) U.S. Cl. CPC G06Q 30/0625; G06Q 30/0202

(57) ABSTRACT

A system including a processor and a non-transitory computer-readable media storing computing instructions that, when executed on the processor, cause the processor to perform certain operations: generating a first ambiguity score for a first query; propagating the first ambiguity score for the first query to generate a second ambiguity score for a second query; training a machine-learning classifier at least based on the first query and the second query; and generating, using the machine-learning classifier, a third ambiguity score for a third query. Other embodiments are described.

### CROSS-REFERENCE TO RELATED APPLICATION

This application claims the benefit of U.S. Provisional Application No. 63/627,394, filed Jan. 31, 2024, which is incorporated herein by reference in its entirety.

### TECHNICAL FIELD

This disclosure relates generally to identification of ambiguous queries based on product type specificity.

### BACKGROUND

User queries and intents are spread across a wide range of spectrum. User queries are typically understood for explicit intents. For example, there can be explicit intents for product types, brands, and other attributes. Implicit intents are more difficult to understand in user queries, but when understood well, can be used to provide more relevant search results.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for search query ambiguity analysis, according to an embodiment;

FIG. 4 illustrates a flow chart for a method of identifying of ambiguous queries based on product type specificity, according to an embodiment; and

FIG. 5 illustrates a method of using a product type specificity classifier, along with examples of using the product type specificity classifier for queries.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

A number of embodiments can include a system including a processor and a non-transitory computer-readable media storing computing instructions that, when executed on the processor, cause the processor to perform certain operations: generating a first ambiguity score for a first query; propagating the first ambiguity score for the first query to generate a second ambiguity score for a second query; training a machine-learning classifier at least based on the first query and the second query; and generating, using the machine-learning classifier, a third ambiguity score for a third query.

Various embodiments include a computer-implemented method. The method can be implemented via execution of computing instructions configured to run at one or more processors and configured to be stored at non-transitory computer-readable media. The method can comprise generating a first ambiguity score for a first query; propagating the first ambiguity score for the first query to generate a second ambiguity score for a second query; training a machine-learning classifier at least based on the first query and the second query; and generating, using the machine-learning classifier, a third ambiguity score for a third query.

Additional embodiments can include a non-transitory computer-readable media storing computing instructions that, when executed on a processor, cause the processor to perform certain operations: generating a first ambiguity score for a first query; propagating the first ambiguity score for the first query to generate a second ambiguity score for a second query; training a machine-learning classifier at least based on the first query and the second query; and generating, using the machine-learning classifier, a third ambiguity score for a third query.

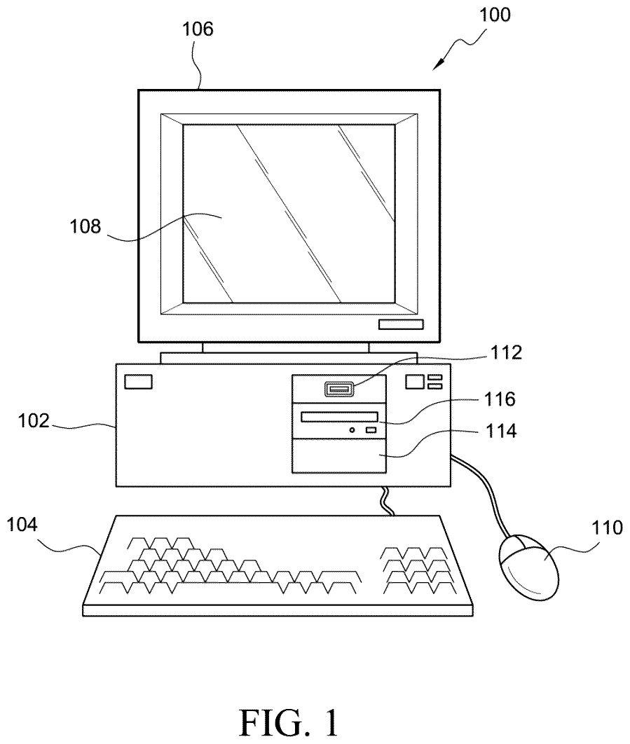

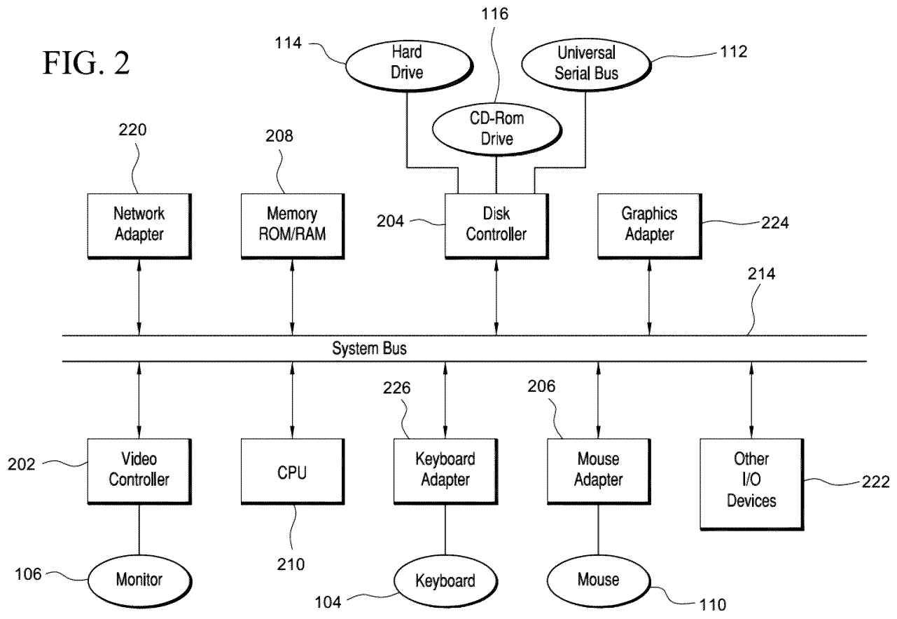

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

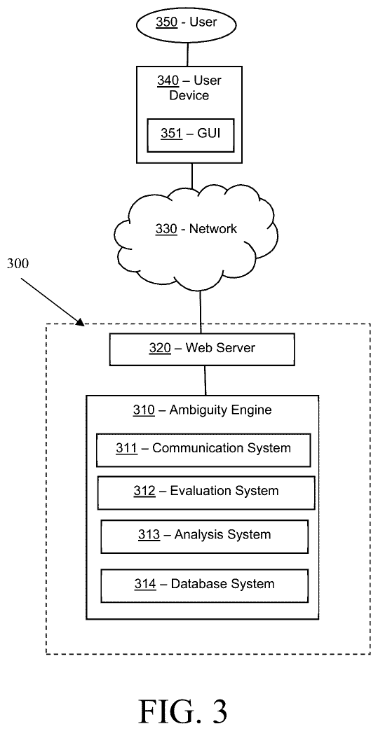

Turning ahead in the drawings, FIG. 3 illustrates a block diagram of a system 300 that can be employed for search query ambiguity analysis, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an ambiguity engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Ambiguity engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host ambiguity engine 310 and/or web server 320. Additional details regarding ambiguity engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with ambiguity engine 310, in addition to other suitable activities. In a number of embodiments, web server 320 can interface with ambiguity engine 310 when a user (e.g., 350) is viewing infrastructure components in order to assist with the analysis of the infrastructure components corresponding to search query analysis.

In some embodiments, an internal network that is not open to the public can be used for communications between ambiguity engine 310 and web server 320 within system 300. Accordingly, in some embodiments, ambiguity engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, ambiguity engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to ambiguity engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of ambiguity engine 310 and/or web server 320. In a similar manner, the processors and/or the non-transitory computer-readable media can be local and/or remote to each other.

Meanwhile, in many embodiments, ambiguity engine 310 and/or web server 320 also can be configured to communicate with one or more databases, such as a database system 314. The one or more databases can include product catalog information, user engagement information, search ambiguity information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, ambiguity engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, ambiguity engine 310 can include a communication system 311, an evaluation system 312, an analysis system 313, and/or database system 314. In many embodiments, the systems of ambiguity engine 310 can be modules of computing instructions (e.g., software modules) stored at non-transitory computer readable media that operate on one or more processors. In other embodiments, the systems of ambiguity engine 310 can be implemented in hardware. ambiguity engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host ambiguity engine 310 and/or web server 320. Additional details regarding ambiguity engine 310 and the components thereof are described herein.

In many embodiments, user device 340 can comprise graphical user interface (“GUI”) 351. In the same or different embodiments, GUI 351 can be part of and/or displayed by user device 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user device 340. In the same or different embodiments, GUI 351 can comprise a website accessed through network 330. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user devices 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, ambiguity engine 310, and/or web server 320 can be configured to communicate with one or more user devices 340. In some embodiments, user devices 340 also can be referred to as customer computers. In some embodiments, ambiguity engine 310, and/or web server 320 can communicate or interface (e.g., interact) with one or more customer computers (such as user devices 340) through a network 330. Network 330 can be an intranet that is not open to the public. In further embodiments, network 330 can be a mesh network of individual systems. Accordingly, in many embodiments, ambiguity engine 310, and/or web server 320 (and/or the software used by such systems) can refer to a back end of system 300 operated by an operator and/or administrator of system 300, and user device 340 (and/or the software used by such systems) can refer to a front end of system 300 used by one or more users 350, respectively. In some embodiments, users 350 can also be referred to as customers, in which case, user device 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

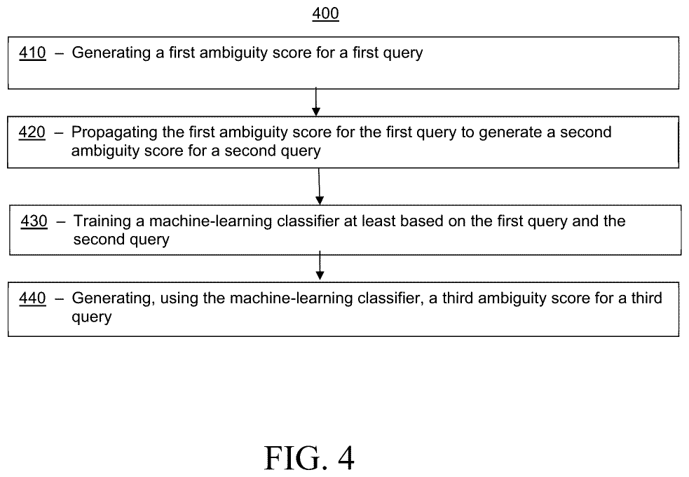

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as ambiguity engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of generating a first ambiguity score for a first query. In some embodiments, generating the first ambiguity score for the first query further comprises determining a specificity count of unique product types purchased based on the first query. In some embodiments, generating the first ambiguity score for the first query further comprises determining a co-purchase probability for the first query. In some embodiments, generating the first ambiguity score for the first query further comprises generating the first ambiguity score for the first query based on the specificity count for the first query and the co-purchase probability for the first query.

In some embodiments, for a query q that generated at least one single purchase, let o_{g,pt} ∈N* be the total number of its corresponding purchases of items of the product type pt, ∥PTs∥∈N* be the count of unique product types of purchased items, and let r_{q,pt} ∈[0,1] be the relative number of orders covered by pt, which is represented as follows:

$${r}_{q , pt} = {o}_{q , pt} / {\sum }_{pt ∈ PTs} {o}_{q , pt}$$

Because broad (e.g., less specific) queries generally attract orders across a large number of unique product types, a specificity count S_{Count} for query q can be based on the count of unique product type PT, as follows:

$${S}_{Count} ( q ) = \frac{1}{[ 1 + ln ( ‖ PTs ‖ ) ]}$$

The count of unique product types can be dampened using natural log because there is often noise in user engagement data, in which there are orders unrelated to the query, even for very specific queries.

If a query q is very narrow, then the probability that two random customers a and b would end up buying the same product type is expected to be high. This co-purchase probability P₂ is calculated as:

$$\begin{matrix}{P}_{2} ( q ) = {\sum }_{pt ∈ PTs} Probability ( a buys pt ) \times Probability ( b buys pt ) \\ = {\sum }_{pt ∈ PTs} {( {r}_{q , pt} )}^{2} \\ = {[ {L}_{2} ( q ) ]}^{2}\end{matrix}$$

where L₂(q) is the L₂ norm of the vector whose elements are the values r_{q,i} for query q. Because the distribution of the score is close to 0, the distribution can be spread by using the L₂ norm directly instead of its square.

A base ambiguity score can be calculated as follows:

$${Specificity}_{Base} ( q ) = {L}_{2} ( q ) / \sqrt{1 + ln ( ‖ PTs ‖ )}$$

The base ambiguity score can provide a baseline measure of ambiguity. However, there can be some limitations to using this score.

To address this and other issues, various constraints can be imposed on ambiguity scores, such as the following:
Constraint 1 (C1): Regardless of the historical engagement data, if a query has more explicit attributes than another one, then it can be scored as less ambiguous. E.g., “samsung tv” is less ambiguous than both its subqueries “samsung” and “tv.”
Constraint 2 (C2): Different variations in explaining the same intent can result in an identical ambiguity across such variations. E.g., “samsung tv 32 in” and “32 inch samsung television” can be scored as having the same ambiguity. Queries can be normalized (to address differences in capitalization, different spellings, typographical errors or misspellings, etc.) and synonyms can be considered. These queries can be considered equivalent.
Constraint 3 (C3): Equivalent intents can be set to have an identical ambiguity score. E.g., “samsung tv 32 in” and “samsung tv 55 in” can be scored as having the same ambiguity. These can be considered sibling queries.
Constraint 4 (C4): Not all attributes are valid for identifying equivalent intents. E.g., “organic food” and “vegetarian food” do not necessarily have the same ambiguity. For example, the following attributes can be eligible: gender, color, character, size, age, quantity, price; while the following attributes can be ineligible: product type, product type descriptor.

In many embodiments, method 400 can comprise an activity 420 of propagating the first ambiguity score for the first query to generate a second ambiguity score for a second query. In some embodiments, propagating the first ambiguity score for the first query to generate the second ambiguity score for the second query further comprises determining that the second query is equivalent to the first query, and setting the second ambiguity score for the second query to be equivalent to the first ambiguity score for the first query.

In some embodiments, propagating the first ambiguity score for the first query to generate the second ambiguity score for the second query further comprises determining that the second query is a subquery of the first query, and setting the second ambiguity score for the second query to represent a lower ambiguity than the first ambiguity score for the first query.

In some embodiments, propagating the first ambiguity score for the first query to generate the second ambiguity score for the second query further comprises determining that the second query is a sibling of the first query, and setting the second ambiguity score for the second query and the first ambiguity score for the first query to be equivalent to a minimum ambiguity of queries that are siblings to the first query and the second query.

In some embodiments, determining that the second query is the sibling of the first query further comprises excluding attributes of product type, or product type descriptor in determining that the second query is the sibling of the first query.

In some embodiments, propagating the first ambiguity score for the first query to generate the second ambiguity score for the second query further comprises applying token-level comparison attributes across identical attributes of the first query and the second query.

In some embodiments, activity 420 can include performing multi-attribute score propagation on queries. In some cases, the propagation can be performed on queries that have no more than 10 tags. To satisfy the constraint C2, queries can be grouped with identical intents using the query normalization logic, and the user engagement (orders) across a group of equivalent queries can be summed up (before calculating the score), which is used in the ambiguity score, such that the ambiguity score is based on the sum across the equivalent queries and each of the equivalent queries is assigned the same ambiguity score.

To satisfy the constraint C1 for subqueries, the following loop can be performed over queries that have more than one tag, l, and in which at least one of the tags l is product type, brand, product line, or miscellaneous:

For l∈[2, 10]:

For every query q with l tags including PT and PT descriptor:

$${Specificity}_{Tmp} ( q ) = tanh [ atanh ( {Specificity}_{Base} ( q ) ) + atanh ( {max}_{{q}^{′} ∈ q} S ( {q}^{′} ) ) ]$$

The atanh moves the scores to the unbounded range [0, +∞[, and tanh squashes the scores back to the range [0, 1]. For the query “samsung 32in tv,” as an example, the following are all q′ E q subqueries: “samsung”, “tv”, “32 in”, “samsung tv”, “samsung 32in”, “32in tv”. l′ is the number of tags for the subquery q′.

To satisfy the constraints C3 and C4, the scores of sibling queries q₁ . . . qₙ can be equalized, as follows:

$$Specificity ( {q}_{1} ) = … = Specificity ( {q}_{n} ) = {min}_{i} Specificity ( {q}_{i} )$$

As an example, “samsung tv 32in” and “samsung tv 55in” are sibling queries.

In some embodiments, single-attribute score propagation can be performed on queries. Consider the example of the query “organic almond milk,” which includes tags of “almond milk” (as a product type) and “organic” (as a product type descriptor), and the query “milk,” which includes the tag “milk” (as a product type). Almond milk is a more specific term than milk, so the score propagation process described above for multi-attribute queries can be applied at the token level (e.g., space-separated) of single-attribute queries, so that Specificity (almond milk)>Specificity (milk). However, this single attribute propagation does not consider tags of different attributes, such as “almond” as a product type descriptor, and “almond milk” as a product type. Similarly, the attribute “milk” (as a product type descriptor) in “milk chocolate” is not propagated to the attribute “almond milk” (as a product type).

In some embodiments, a score-back propagation can be determined based on the first ambiguity score for the first query to generate the second ambiguity score for the second query. In some embodiments, the score-back propagation corresponds to a ratio between a current query and a sub-query of the current query. In some embodiments, the score-back propagation can be determine using an equation comprising:

$${S}_{New} ( q ) = \frac{{s}_{Old} ( q )}{{max}_{{q}^{′} ∈ \{ q \} ⋃ Descendants ( q )} {s}_{Old} ( {q}^{′} )} ,$$

wherein S_{Old}(q) is the score of a query q before back-propagation, S_{New}(q) is the score of the same query q after back-propagation, and q′ is wither the query q itself or one of its descendants. Descendants of a query are its subqueries, or the subqueries of its subqueries and henceforth.

In many embodiments, method 400 can comprise an activity 430 of training a machine-learning classifier at least based on the first query and the second query. In some embodiments, training the machine-learning classifier can include applying an ambiguity classifier. In many embodiments, the ambiguity classifier transforms query embeddings to an ambiguity score. In many embodiments, the ambiguity classifier can be a binary classifier, which can output an ambiguity score between 0 (representing no ambiguity) and 1 (representing complete ambiguity). For example, the score can be a sum of learned parameter weights multiplied by the respective embeddings. Each of the parameter weights can be learned during training using the ambiguity scores for known queries. In many embodiments, a non-linear classifier can be used. In a number of embodiments, various machine learning models can be used, such as logistic regression, k-nearest neighbors, convolutional neural network, trees, random forest, etc.

In many embodiments, method 400 can comprise an activity 440 of generating, using the machine-learning classifier, a third ambiguity score for a third query. In some embodiments, activity 440 can include determining whether the third ambiguity score for the third query meets a predetermined threshold. In some embodiments, when the third ambiguity score for the third query meets the predetermined threshold, displaying one or more items in one or more sections of a graphical user interface in response to a search using the third query.

In many embodiments, when a query has an ambiguity score, that ambiguity score can be used in various different use cases. For example, if the ambiguity score for a query is higher than a threshold, then the results displayed for the search query can be different than if the ambiguity score for the query is lower than a threshold. An exemplary use case is whether to display items in multiple stacks in the search results for a query. Ambiguous queries (e.g., “gifts for mom”, or “toys for toddlers”) generally have many product types associated with them. Organizing their presentation into separate stacks of homogeneous products would help the customer navigate through the results page. The items for less ambiguous queries (e.g., “bananas”, “samsung tv”) on the other hand might be better presented as a single result set. We can decide which experience to enable for different queries based on the ambiguity score and a fixed threshold (e.g., <=0.5).

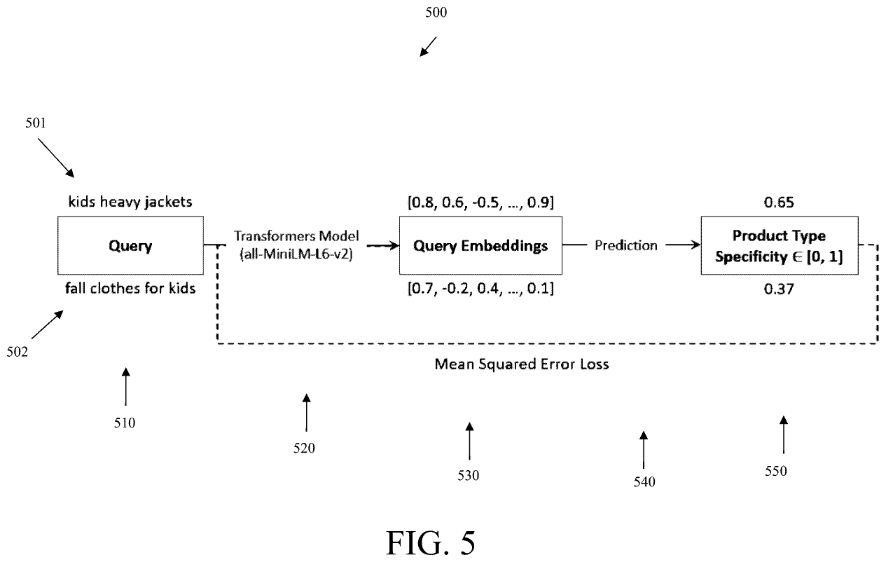

Turning ahead in the drawings, FIG. 5 illustrates a method 500 of using a product type specificity classifier, along with examples of using the product type specificity classifier for queries 501 and 502. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

As shown in FIG. 5, method 500 can include an activity 510 of receiving a query. The query can be similar or identical to query 501 (e.g., “kids heavy jackets”) and/or query 502 (e.g., fall clothes for kids).

Next, method 500 can include an activity 520 of transforming the query to query embeddings. In many embodiments, activity 520 can use a sequence transformer model, which can take the query as input and can output a vector of query embeddings.

Next, method 500 can include an activity 530 of outputting the query embeddings from the transformer model. For example, as shown in FIG. 5, for query 501, the query embeddings can be [0.8, 0.6,−0.5, . . . , 0.9], and for query 502, the query embeddings can be [0.7, −0.2, 0.4, . . . , 0.1].

Next, method 500 can include an activity 540 of applying a product type specificity classifier. In many embodiments, the product type specificity classifier transforms the query embeddings to a specificity score. In many embodiments, the product type specificity classifier can be a binary classifier, which can output a specificity score between 0 (representing no specificity) and 1 (representing complete specificity). For example, the score can be a sum of learned parameter weights multiplied by the respective embeddings. Each of the parameter weights can be learned during training using the specificity scores for known queries. In many embodiments, a non-linear classifier can be used. In a number of embodiments, various machine learning models can be used, such as logistic regression, k-nearest neighbors, convolutional neural network, trees, random forest, etc.

Next, method 500 can include an activity 550 of outputting the specificity (SPC) score. For example, the specificity score for query 501 can be 0.65, and the specificity score for query 502 can be 0.37, indicating that query 501 is more specific than query 502.

Returning to FIG. 3, in several embodiments, communication system 311 can at least partially perform activity 410 (FIG. 4). In several embodiments, evaluation system 312 can at least partially perform activity 420 (FIG. 4), and/or activity 430 (FIG. 4). In a number of embodiments, analysis system 313 can at least partially perform activity 440 (FIG. 4). In a number of embodiments, web server 320 can at least partially perform method 400.

Although systems and methods for ambiguity analysis have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

In many embodiments, the techniques described herein can provide a practical application and several technological improvements. In some embodiments, the techniques described herein can provide for engagement-based estimation of query ambiguity. The techniques described herein can provide a significant improvement over conventional approaches that fail to take into account the ambiguity of search queries.

In a number of embodiments, the techniques described herein can solve a technical problem that arises only within the realm of computer networks, as search queries for online search engines do not exist outside the realm of computer networks. Moreover, the techniques described herein can solve a technical problem that cannot be solved outside the context of computer networks. Specifically, the techniques described herein cannot be used outside the context of computer networks, in view of a lack of data, the lack of search result pages, and the inability to perform machine learning models without a computer.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
generating a first ambiguity score for a first query;
propagating the first ambiguity score for the first query to generate a second ambiguity score for a second query;
training a machine-learning classifier at least based on the first query and the second query; and
generating, using the machine-learning classifier, a third ambiguity score for a third query.

2. The system of claim 1, wherein generating the first ambiguity score for the first query further comprises:
determining a specificity count of unique product types purchased based on the first query;
determining a co-purchase probability for the first query; and
generating the first ambiguity score for the first query based on the specificity count for the first query and the co-purchase probability for the first query.

3. The system of claim 1, wherein propagating the first ambiguity score for the first query to generate the second ambiguity score for the second query further comprises:
determining that the second query is equivalent to the first query; and
setting the second ambiguity score for the second query to be equivalent to the first ambiguity score for the first query.

4. The system of claim 1, wherein propagating the first ambiguity score for the first query to generate the second ambiguity score for the second query further comprises:
determining that the second query is a subquery of the first query; and
setting the second ambiguity score for the second query to represent a lower ambiguity than the first ambiguity score for the first query.

5. The system of claim 1, wherein propagating the first ambiguity score for the first query to generate the second ambiguity score for the second query further comprises:
determining that the second query is a sibling of the first query; and
setting the second ambiguity score for the second query and the first ambiguity score for the first query to be equivalent to a minimum ambiguity of queries that are siblings to the first query and the second query.

6. The system of claim 5, wherein determining that the second query is the sibling of the first query further comprises:
excluding attributes of product type, or product type descriptor in determining that the second query is the sibling of the first query.

7. The system of claim 1, wherein propagating the first ambiguity score for the first query to generate the second ambiguity score for the second query further comprises:
applying token-level comparison attributes across identical attributes of the first query and the second query.

8. The system of claim 1, further comprising performing a score-back propagation on the first ambiguity score for the first query to generate the second ambiguity score for the second query, wherein the score-back propagation corresponds to a ratio between a current query and a sub-query of the current query.

9. The system of claim 1, wherein the operations further comprise:
determining whether the third ambiguity score for the third query meets a predetermined threshold.

10. The system of claim 9, wherein the operations further comprise:
when the third ambiguity score for the third query meets the predetermined threshold, displaying one or more items in one or more sections of a graphical user interface in response to a search using the third query.

11. A computer-implemented method comprising:
generating a first ambiguity score for a first query;
propagating the first ambiguity score for the first query to generate a second ambiguity score for a second query;
training a machine-learning classifier at least based on the first query and the second query; and
generating, using the machine-learning classifier, a third ambiguity score for a third query.

12. The computer-implemented method of claim 11, wherein generating the first ambiguity score for the first query further comprises:
determining a specificity count of unique product types purchased based on the first query;
determining a co-purchase probability for the first query; and
generating the first ambiguity score for the first query based on the specificity count for the first query and the co-purchase probability for the first query.

13. The computer-implemented method of claim 11, wherein propagating the first ambiguity score for the first query to generate the second ambiguity score for the second query further comprises:
determining that the second query is equivalent to the first query; and
setting the second ambiguity score for the second query to be equivalent to the first ambiguity score for the first query.

14. The computer-implemented method of claim 11, wherein propagating the first ambiguity score for the first query to generate the second ambiguity score for the second query further comprises:
determining that the second query is a subquery of the first query; and
setting the second ambiguity score for the second query to represent a lower ambiguity than the first ambiguity score for the first query.

15. The computer-implemented method of claim 11, wherein propagating the first ambiguity score for the first query to generate the second ambiguity score for the second query further comprises:
determining that the second query is a sibling of the first query; and
setting the second ambiguity score for the second query and the first ambiguity score for the first query to be equivalent to a minimum ambiguity of queries that are siblings to the first query and the second query.

16. The computer-implemented method of claim 15, wherein determining that the second query is the sibling of the first query further comprises:
excluding attributes of product type, or product type descriptor in determining that the second query is the sibling of the first query.

17. The computer-implemented method of claim 11, wherein propagating the first ambiguity score for the first query to generate the second ambiguity score for the second query further comprises:
applying token-level comparison attributes across identical attributes of the first query and the second query.

18. The computer-implemented method of claim 11, further comprising performing a score-back propagation on the first ambiguity score for the first query to generate the second ambiguity score for the second query, wherein the score-back propagation corresponds to a ratio between a current query and a sub-query of the current query.

19. A non-transitory computer-readable medium storing computing instructions that, when executed on a processor, cause the processor to perform operations comprising:
generating a first ambiguity score for a first query;
propagating the first ambiguity score for the first query to generate a second ambiguity score for a second query;
training a machine-learning classifier at least based on the first query and the second query; and
generating, using the machine-learning classifier, a third ambiguity score for a third query.

20. The non-transitory computer-readable medium of claim 19, wherein generating the first ambiguity score for the first query further comprises:
determining a specificity count of unique product types purchased based on the first query;
determining a co-purchase probability for the first query; and
generating the first ambiguity score for the first query based on the specificity count for the first query and the co-purchase probability for the first query.
